(19) United States
(12) Patent Application Publication
(10) Pub. No.: US 2011/0141505 A1
(43) Pub. Date: Jun. 16, 2011

(54) PRINTING SYSTEM, PRINTER DRIVER AND COPIER

(75) Inventor: Hiroyuki Haga, Azumino-shi (JP)

(73) Assignee: SEIKO EPSON CORPORATION, Shinjuku-ku (JP)

(21) Appl. No.: 12/969,383

(22) Filed: Dec. 15, 2010

(30) Foreign Application Priority Data
Dec. 16, 2009 (JP) 2009-285006
May 17, 2010 (JP) 2010-112918

(51) Int. Cl. H04N 1/60

(52) U.S. Cl. 358/1.9

(57) ABSTRACT

Disclosed is a printing system including a printing device having one or more feeders, and a computer. The computer includes a setting reception unit that stores beforehand a setting of ON or OFF of a colorant save mode in which a process of saving a colorant is performed for every one of the feeders, and receives a print instruction including selection of a feeder, and a command sending unit that, on the basis of the feeder selected in the print instruction and a setting of ON or OFF of the colorant save mode of the feeder, generates a print command and sends the print command to the printing device. The printing device includes a print control unit that, on the basis of the print command sent from the computer, performs a predetermined process of saving a colorant when the colorant save mode is ON, generates print data, and carries out printing using the feeder selected in the print command.

### BACKGROUND

1. Technical Field

The present invention relates to an image forming device such as a printer, a multifunction printer or a copier, an image forming system including the image forming device, and a driver program for controlling the image forming device, and more particularly to toner saving.

2. Related Art

Some image forming devices, such as printers, multifunction printers and copiers, have toner save modes in which toner consumption is reduced more than in normal modes (see, for example, JP-A-2006-276058).

Examples of cases where a user wants to use a toner save mode include the case of printing of a draft copy and a memorandum, and the case of printing on a paper sheet whose surface on one side has already been printed on, a so-called backing sheet. Thus, for data of little importance to the user, a user tends to use a toner save mode.

With an existing printer having a toner save mode, however, when wanting to carry out printing in the toner save mode, a user needs to switch the setting of the toner save mode to ON (valid) in a window for setting a printer driver that operates in a host computer such as a personal computer (PC). Therefore, in the case of using the toner save mode, a user needs to switch the setting of the toner save mode every time the user carries out printing. This results in reduced ease-of-use. In particular, such a setting method lacks convenience for a user who uses the toner save mode more often than the normal mode.

### SUMMARY

An advantage of some aspects of the invention is that the ease-of-use of the toner save mode is improved.

According to a first aspect of the invention for solving the above problem, a printing system includes a printing device having one or more feeders, and a computer. The computer includes a setting reception unit that stores beforehand a setting of ON or OFF of a colorant save mode in which a process of saving a colorant is performed for every one of the feeders, and receives a print instruction including selection of a feeder, and a command sending unit that, on the basis of the feeder selected in the print instruction and a setting of ON or OFF of the colorant save mode of the feeder, generates a print command and sends the print command to the printing device. The printing device includes a print control unit that, on the basis of the print command sent from the computer, performs a predetermined process of saving a colorant when the colorant save mode is ON, generates print data, and carries out printing using the feeder selected in the print command.

According to a second aspect of the invention for solving the above problem, a printing system includes a printing device having one or more feeders, and a computer. The computer includes a setting reception unit that stores beforehand a setting of ON or OFF of a colorant save mode in which a process of saving a colorant is performed for every one of the feeders, and receives a print instruction including selection of a feeder, and a command sending unit that, on the basis of the feeder selected in the print instruction and ON or OFF of the colorant save mode of the feeder, performs a predetermined process of saving a colorant when the colorant save mode is ON, generates a print command, and sends the print command to the printing device. The printing device includes a print control unit that, on the basis of the print command sent from the computer, generates print data, and carries out printing using the selected feeder.

Here, in the above printing system, the setting reception unit may receive a setting of ON or OFF of the colorant save mode for the selected feeder, and the command sending unit may generate a print command on the basis of the setting of ON or OFF of the colorant save mode received for the selected feeder.

In this printing system, the setting reception unit may receive a change of the beforehand stored setting of ON or OFF of the colorant save mode for every feeder.

According to a third aspect of the invention for solving the above problem, a computer readable storage medium includes a printer driver program stored thereon that causes a computer to function as a device for sending a print command to a printing device having one or more feeders. The printer driver program causes the computer to function as a setting reception unit that stores beforehand a setting of ON or OFF of a colorant save mode in which a process of saving a colorant is performed for every one of the feeders, and receives a print instruction including selection of a feeder, and as a command sending unit that, on the basis of the feeder selected in the print instruction and ON or OFF of the colorant save mode of the feeder, generates a print command, and sends the print command to the printing device.

According to a fourth aspect of the invention for solving the above problem, a computer readable storage medium includes a printer driver program stored thereon that causes a computer to function as a device for sending a print command to a printing device having one or more feeders. The printer driver program causing the computer to function as a setting reception unit that stores beforehand a setting of ON or OFF of a colorant save mode in which a process of saving a colorant is performed for every one of the feeders, and receives a print instruction including selection of a feeder, and as a command sending unit that, on the basis of the feeder selected in the print instruction and ON or OFF of the colorant save mode of the feeder, performs a predetermined process of saving a colorant when the colorant save mode is ON, generates a print command, and sends the print command to the printing device.

According to a fifth aspect of the invention for solving the above problem, a copier having one or more feeders includes a setting reception unit, a reading control unit and a print control unit. The setting reception unit stores beforehand a setting of ON or OFF of a colorant save mode in which a process of saving a colorant is performed for every one of the feeders, and receives a copy instruction including selection of a feeder. The reading control unit generates scan data on the basis of the copy instruction. On the basis of the feeder selected in the copy instruction and a setting of ON or OFF of the colorant save mode of the feeder, the print control unit performs a predetermined process of saving a colorant when the colorant save mode is ON, generates print data, and carries out printing using the selected feeder.

Here, the copier may further include an operation panel for receiving an operation of a user. In the copier, the setting reception unit may receive, through the operation panel, a setting of ON or OFF of a colorant save mode for the selected feeder, and the print control unit may generate print data on the basis of the setting of ON or OFF of the colorant save mode received for the selected feeder.

In the copier, the feeders may each have a physical switch that allows ON or OFF of the colorant save mode to be set, and the setting reception unit may receive a change of the beforehand stored setting of ON or OFF of the colorant save mode for every feeder.

### BRIEF DESCRIPTION OF THE DRAWINGS

The invention will be described with reference to the accompanying drawings, wherein like numbers reference like elements.

FIG. 1 is a block diagram showing a schematic hardware configuration of a printing system according to an embodiment of the invention.

FIG. 2 is a block diagram showing a functional configuration of the printing system.

FIG. 3 is table showing an example of toner save setting information.

FIG. 4 shows an example of an interface screen for selecting a feeder.

FIG. 5 shows an example of an interface screen for settings of printing quality.

FIG. 6 shows an example of an interface screen for a setting of the toner save mode of the selected feeder.

FIG. 7 shows an example of an interface screen for an initial setting of the toner save mode for every feeder.

FIG. 8 illustrates an example of a method of setting the toner save mode for every feeder of a printer.

FIG. 9 is a flowchart showing a printing process in the printing system.

### DESCRIPTION OF EXEMPLARY EMBODIMENTS

An embodiment of the invention is now described with reference to the accompanying drawings.

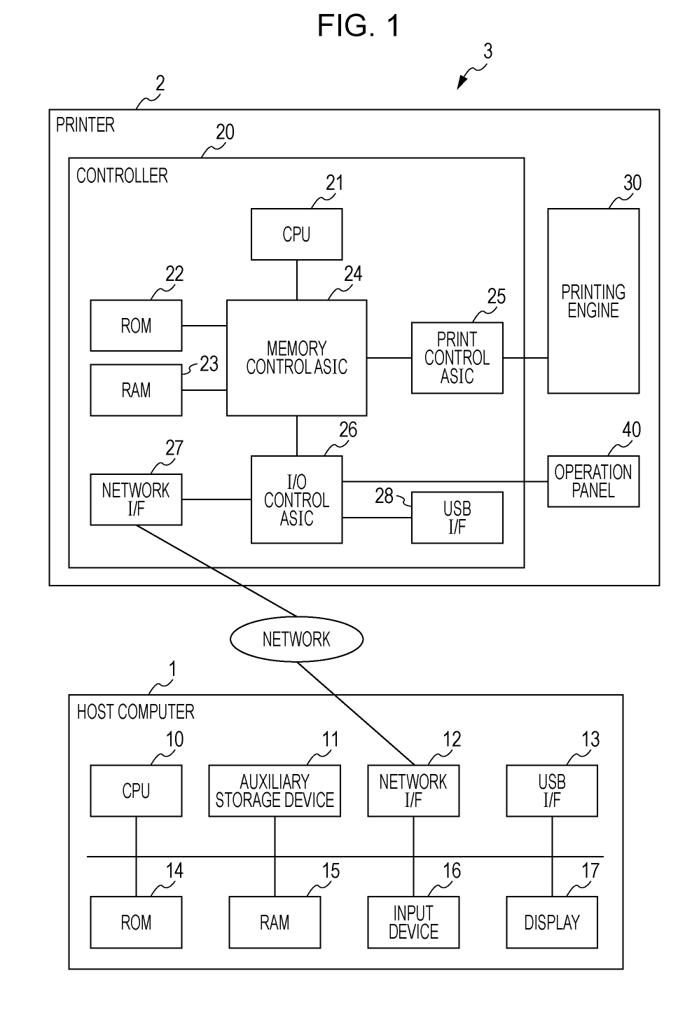

FIG. 1 is a block diagram showing a schematic hardware configuration of a printing system 3 according to an embodiment of the invention.

The printing system 3 serving as an image forming system includes a printer 2 serving as an image forming device, and a host computer 1 for controlling the printer 2. The host computer 1 and the printer 2 can communicate with each other via a network such as a local area network (LAN). The host computer 1, in which a printer driver program is installed, controls the printer 2 with the printer driver program.

As a matter of course, the printing system 3 may include a plurality of host computers 1. Each host computer 1 may communicate with the printer 2.

The host computer 1 is a typical computer that includes, for example, a central processing unit (CPU) 10 for performing various operations, an auxiliary storage device 11 such as a hard disk drive (HDD) for storing various programs and data, a network interface (I/F) 12 for communicating with an external device via a network such as a LAN, a universal serial bus (USB) I/F 13, which includes a USB port and a USB controller, for communicating with an external device by means of a USB, a read-only memory (ROM) 14 for storing preloaded programs and data necessary for activation, a random-access memory (RAM) 15 for storing programs and data to be executed by the CPU 10, an input device 16 such as a keyboard and a mouse, and a display 17 such as a liquid crystal display (LCD) on which a user interface screen or the like is displayed.

The printer 2 is a typical laser page printer that includes, for example, a controller 20, a printing engine 30 and an operation panel 40. The printer 2 has a toner save mode, the details of which will be described later.

The controller 20 includes, for example, a CPU 21, a ROM 22, a RAM 23, a memory control application specific integrated circuit (ASIC) 24, a print control ASIC 25, an input/output (I/O) control ASIC 26, a network I/F 27 and a USB I/F 28.

The CPU 21 executes a predetermined program to control the printer 2 in an integrated manner. The ROM 22 is a nonvolatile memory that stores data, programs and the like, and is, for example, a flash memory. The ROM 22 may be connected to the I/O control ASIC 26, but not to the memory control ASIC 24. The RAM 23 is a nonvolatile memory that temporarily stores data, programs and the like, and is, for example, a double data rate synchronous DRAM (DDR-SDRAM).

The memory control ASIC 24 is a unit that controls access to the ROM 22 and the RAM 23. The memory control ASIC 24 stores in the RAM 23 image data to be printed that has been transmitted from an external device through, for example, the network I/F 27 and the I/O control ASIC 26, or the USB I/F 28 and the I/O control ASIC 26. The memory control ASIC 24 outputs the image data stored in the RAM 23 to the print control ASIC 25.

The print control ASIC 25 is a unit that generates print data capable of being processed in the printing engine 30 and that controls printing by the printing engine 30. The print control ASIC 25 reads out image data, for example, from the RAM 23 and applies predetermined processing (e.g., color conversion, compression, expansion and binarization) to the image data to generate print data. Then, the print control ASIC 25 sends the generated print data to the printing engine 30 to cause the printing engine 30 to carry out printing.

The I/O control ASIC 26 is a unit that controls I/O devices and I/F devices. In this embodiment, the I/O control ASIC 26 is connected to the operation panel 40 as the I/O device and the network I/F 27 and the USB I/F 28 as the I/F devices. As a matter of course, a hard disk drive, a parallel I/F and the like may be connected to the I/O control ASIC 26. For example, through the network I/F 27 or the USB I/F 28, the I/O control ASIC 26 transfers to the CPU 21 data sent from an external device and transfers to the external device data sent from the CPU 21. For example, alternatively, the I/O control ASIC 26 transfers to the CPU 21 a signal output from the operation panel 40 and transfers to the operation panel 40 drawing data transmitted from the CPU 21.

The network I/F 27 is a unit that communicates with an external device, such as the host computer 1, on a network. The network I/F 27 includes, for example, a network controller and a network connector.

The USB I/F 28 is a unit that communicates with an external device such as the host computer 1. The USB I/F 28 includes, for example, a USB controller, a USB connector and the like.

The printing engine 30 is a unit that prints data supplied from the print control ASIC 25 on a print medium. The printing engine 30 is a laser engine having, for example, a toner cartridge, a photosensitive drum, a laser beam irradiation mechanism, a transfer mechanism, a paper feed mechanism, a sheet feeding mechanism, a sheet discharging mechanism and the like.

In this embodiment, a description is given assuming that the sheet feeding mechanism includes sheet feeding trays in which print media are stored, and feeders that feed print media from the sheet feeding trays to the paper feed mechanism, and the sheet feeding mechanism has the feeders such that one of the feeders corresponds to one of the sheet feeding trays. Also, in this embodiment, a description is given assuming that three feeders are provided. As a matter of course, the number of feeders is not limited to three, and need only be one or more. The printing engine 30 is not limited to that of a laser type, and may be that of an ink jet type.

The operation panel 40 is a unit provided, as an input/output interface between a user and the printer 2, in an enclosure of the printer 2. The operation panel 40 has a display such as a liquid crystal display or an organic electro-luminescence (EL) display, a touch panel, a hard switch and the like.

As a matter of course, the above configurations of the host computer 1 and the printer 2 have been described as the main configurations for describing features of the present invention, and the configurations of the host computer 1 and the printer 2 are not limited to those described above. The above configurations are not intended to exclude other configurations that a typical computer and a typical printer have.

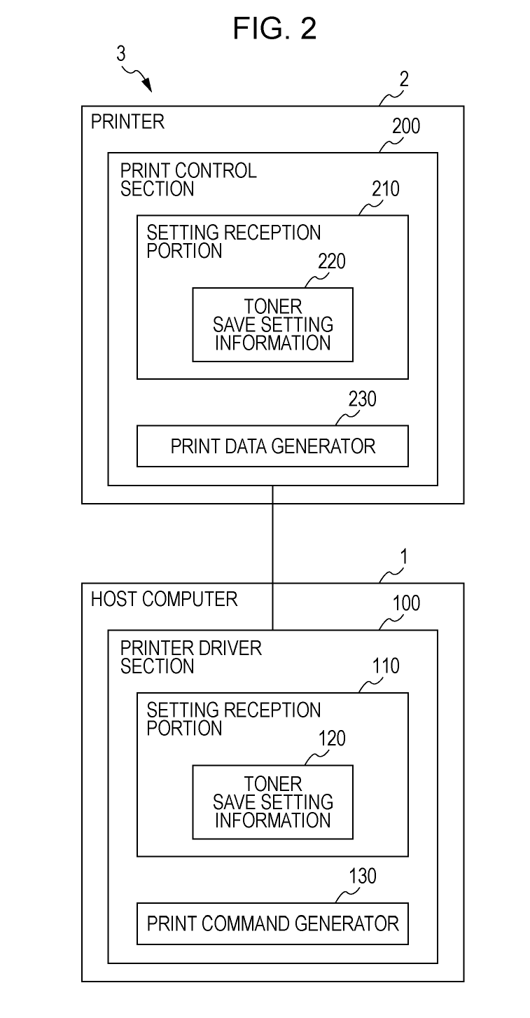

FIG. 2 is a block diagram showing a functional configuration of the printing system 3.

The host computer 1 has a printer driver section 100. The printer driver section 100 has a setting reception portion 110 and a print command generator 130. The setting reception portion 110 has toner save setting information 120.

The printer driver section 100 is implemented, for example, by executing a printer driver program loaded by the CPU 10 from the auxiliary storage device 11 into the RAM 15. The printer driver program is downloaded, for example, from a server on a network and is installed in the host computer 1 or updated. As a matter of course, the printer driver program may be recorded beforehand in a portable recording medium, read from the recording medium, and installed in the host computer 1 or updated.

Note that the host computer 1 may have an operating system (OS) section and an application section (both not shown). The OS section and the application section are implemented, for example, by executing predetermined OS and application programs loaded by the CPU 10 from the auxiliary storage device 11 into the RAM 15.

The printer driver section 100 performs, for example, a display control process for an interface screen configured to receive settings for printing, an input control process for a user's operation through the interface screen, a print command generation process of generating a print command (printing job) or the like that gives an instruction that data to be printed, which has been received from the application section, be printed, and a sending process of sending the print command to the printer 2. To perform these processes, the printer driver section 100 has the setting reception portion 110 and the print command generator 130.

The setting reception portion 110 stores and manages settings for printing. The setting reception portion 110 receives changes of settings for printing and an instruction for starting printing.

For example, the setting reception portion 110 causes an interface screen for receiving various printing settings to be displayed on the display 17. Through the input device 16, the setting reception portion 110 receives changes of the printing settings on the interface screen, and the like. Upon receiving from a user through a printing screen or the like of the application section an instruction that printing of data to be printed be started, the setting reception portion 110 acquires various printing settings set on the interface screen, and requests the print command generator 130 to generate a print command on the basis of the printing settings.

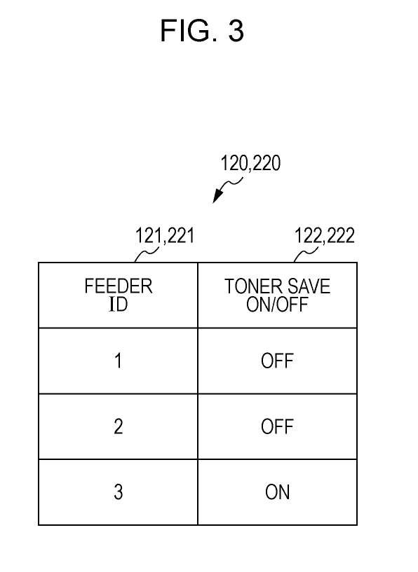

In this embodiment, the setting reception portion 110 manages a setting of ON/OFF (valid/invalid) of the toner save mode for every feeder of the printer 2. Therefore, the setting reception portion 110 has, for example, the toner save setting information 120 as shown in FIG. 3. The toner save setting information 120 has an entry for every feeder. Each entry includes feeder identification (ID) 121, which is information identifying a feeder, and toner save ON/OFF information 122, which is information representing the ON/OFF of the toner save mode.

The original initial value of the toner save ON/OFF information 122 of each entry can be set, for example, to “OFF”. Note that, as will be described later, the toner save ON/OFF information 122 can be changed by a user's operation, and the value changed by the user is set as an initial value.

As a matter of course, the above-mentioned configuration of the toner save setting information 120 is one example, and the configuration is not limited to that mentioned above. The method of managing the toner save setting information 120 is not limited to a method using a table.

Hereinafter, a method of setting ON/OFF of the toner save mode on a feeder-by-feeder basis, which is characteristic of this embodiment, is described.

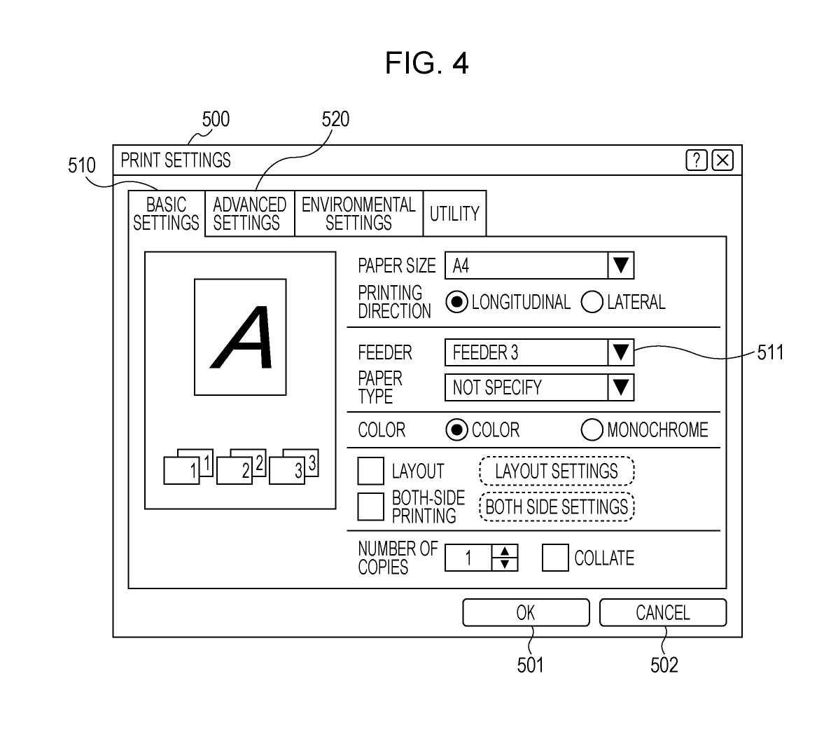

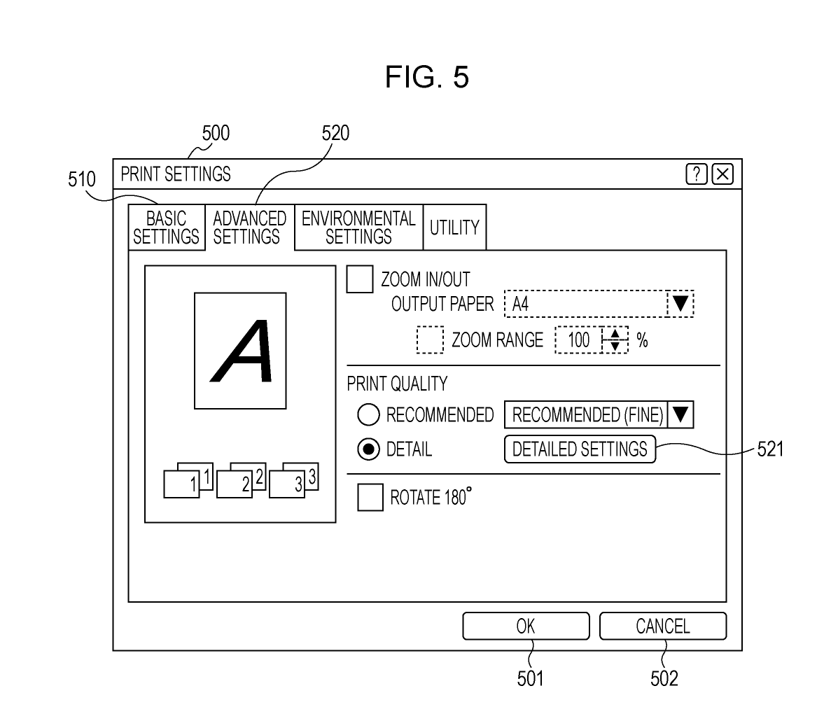

When the printer driver section 100 is activated by a user's operation through the input device 16, the setting reception portion 110 causes an interface screen 500 for receiving various printing settings, for example, as shown in FIGS. 4 and 5, to be displayed on the display 17. Then, through the input device 16, the setting reception portion 110 receives settings for the various printing settings on the interface screen 500.

The interface screen 500 includes a Basic Settings screen 510, an Advanced Settings screen 520, an Environmental Settings screen and a Utility screen, which can be selected with tabs. The interface screen 500 includes an OK button 501 for applying various printing settings on the interface screen 500 as printing settings used for generating a print command, and a Cancel button 502 for cancelling the application of various printing settings.

As shown in FIG. 4, the Basic Settings screen 510 includes, for example, a feeder field 511 for selecting a feeder to be used for printing, as a field in which basic settings for printing are made. As shown in FIG. 5, the Advanced Settings screen 520 includes, for example, a Detailed Settings button 521 for detailed settings for printing quality, as a field in which advanced settings for printing are made.

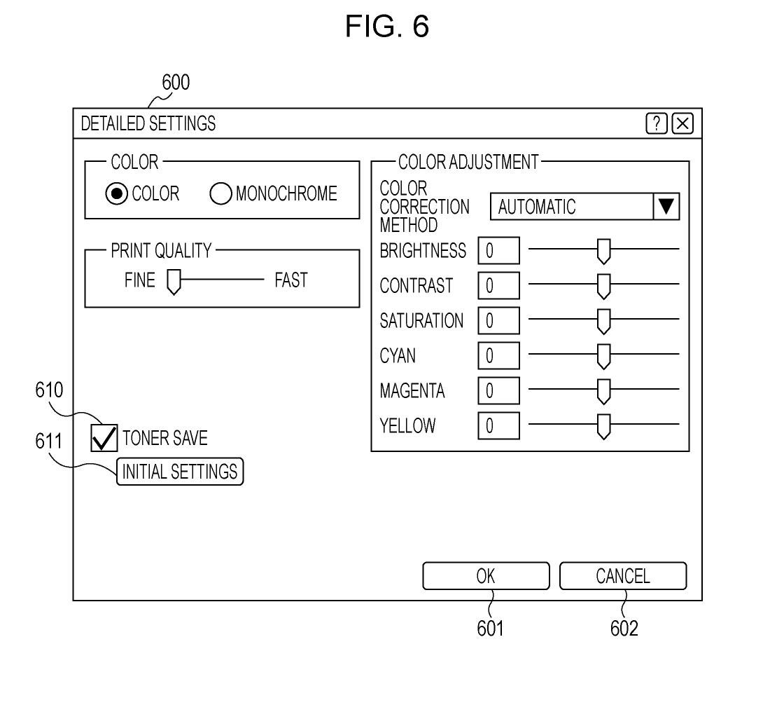

When receiving the selection of the Detailed Settings button 521 on the Advanced Settings screen 520, the setting reception portion 110 displays an interface screen 600 for receiving a setting of ON/OFF of the toner save mode of the selected feeder, for example, as shown in FIG. 6. Then, the setting reception portion 110 receives a setting of ON/OFF of the toner save mode of the selected feeder.

The interface screen 600 includes fields for settings for the quality and color of printing, and also includes a Toner Save field 610 for setting ON/OFF of the toner save mode for a feeder selected in the feeder field 511 of the interface screen 500 and an Initial Settings button 611 for an initial setting of ON/OFF of the toner save mode for every feeder. The interface screen 600 includes an OK button 601 for applying settings on the interface screen 600 as the printing settings and a Cancel button 602 for cancelling the application of settings.

At the time of displaying the interface screen 600, the setting reception portion 110 specifies the ID of a feeder set in the feeder field 511, refers to the toner save setting information 120, and acquires the toner save ON/OFF information 122 of the entry of this feeder ID. Information corresponding to the acquired toner save ON/OFF information 122 (ON or OFF) is displayed in the Toner Save field 610.

For example, in the case where a feeder 3 is set in the feeder field 511 (see FIG. 4) and the toner save ON/OFF information 122 of the feeder 3 is set to ON (see FIG. 3), the Toner Save field 610 is set to ON (in FIG. 6, the check box is checked).

As described above, a user can freely change the setting of the Toner Save field 610. However, the content of the toner save ON/OFF information 122 does not change. That is, the default setting of the Toner Save field 610 at the time of displaying the interface screen 600 follows the toner save ON/OFF information 122.

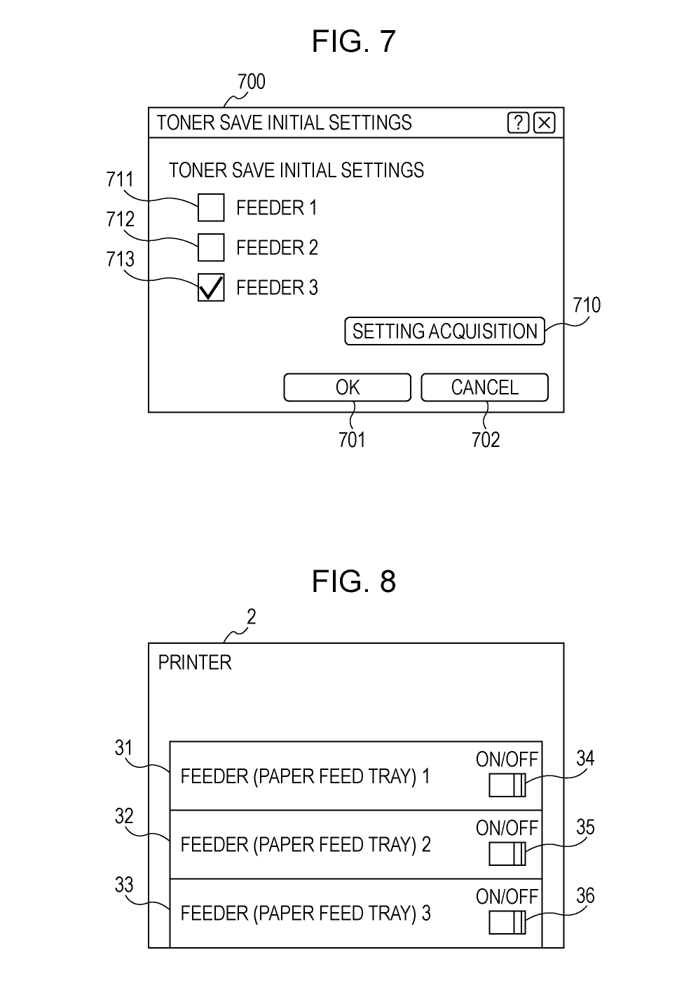

When receiving selection of the Initial Settings button 611 on the interface screen 600, the setting reception portion 110 displays an interface screen 700 for an initial setting of ON/OFF of the toner save mode for every feeder, for example, as shown in FIG. 7. Then, the setting reception portion 110 receives an initial setting of ON/OFF of the toner save mode for every feeder.

The interface screen 700 includes Initial Settings fields 711 to 713 for setting ON/OFF of the toner save mode for every feeder, and a Setting Acquisition button 710 for acquiring information on ON/OFF of the toner save mode on a feeder-by-feeder basis, which is set in the printer 2, from the printer 2. The interface screen 700 includes an OK button 701 for applying settings on the interface screen 700 as the initial settings for the feeders and a Cancel button 702 for cancelling the application of settings.

At the time of displaying the interface screen 700, the setting reception portion 110 refers to the toner save setting information 120, and acquires the toner save ON/OFF information 122 of every feeder. Information corresponding to the acquired toner save ON/OFF information 122 (ON or OFF) for every feeder is displayed in the Initial Settings fields 711 to 713.

For example, in the case where the toner save ON/OFF information 122 of the feeder 3 is set to ON (see FIG. 3), the Initial Settings field 713 is set to ON (the check box is checked in FIG. 7).

When receiving selection of the OK button 701 on the interface screen 700, the setting reception portion 110 reflects settings of the Initial Settings fields 711 to 713 of the feeders in the toner save ON/OFF information 122 of the toner save setting information 120. The setting reception portion 110 also reflects the settings in the Toner Save field 610 of the interface screen 600. Note that the display of the interface screen 700 can be configured to be erased when the OK button 701 is selected.

When receiving selection of the Setting Acquisition button 710 on the interface screen 700, the setting reception portion 110 sends to the printer 2 a command requesting information (the toner save setting information 220) that represents ON/OFF of the toner save mode set for every feeder. Upon receiving that information from the printer 2, the setting reception portion 110 displays in the Initial Settings fields 711 to 713 information corresponding to the received toner save on/off information 222 (ON or OFF) of every feeder.

As described above, a user can freely change settings of the Initial Settings fields 711 to 713. The user can also freely change settings of the Initial Settings fields 711 to 713 so as to be the same as the setting of the printer 2 by selecting the Setting Acquisition button 710. However, without selecting the OK button 701, the content of the toner save ON/OFF information 122 does not change.

Hereinabove, the method of setting ON/OFF of the toner save mode on a feeder-by-feeder basis in the printer driver section 100, which is characteristic of this embodiment, has been described. As a matter of course, the above configurations and screen transition of the interface screens are one example, and the configurations and screen transition are not limited to those described above.

With reference back to FIG. 2, upon receiving a printing request from the setting reception portion 110, the print command generator 130 acquires from the setting reception portion 110 various printing settings set on the interface screen. The print command generator 130 also acquires data to be printed that is specified through the application section. The print command generator 130 generates a print command including various printing settings and data to be printed. The print command generator 130 sends the generated print command to the printer 2 and causes the printer 2 to carry out printing on the basis of that print command.

In this embodiment, the print command includes information identifying a feeder selected in the feeder field 511 and information representing ON/OFF of the toner save mode for the feeder set in the Toner Save field 610.

The printer 2 has a print control section 200. The print control section 200 has a setting reception portion 210 and a print data generator 230. The setting reception portion 210 has the toner save setting information 220.

The print control section 200 is implemented, for example, mainly by executing the predetermined programs that the CPU 21 has loaded from the ROM 22 into the RAM 23. Part of the processing may be implemented by the print control ASIC 25. The predetermined programs may be, for example, downloaded from a server and updated.

The print control section 200 performs a display control process for an interface screen configured to receive settings for printing, an input control process for a user's operation through the interface screen, a process of generating print data in accordance with a print command received from the host computer 1, and the like. The print control section 200 controls the printing engine 30 on the basis of the generated print data, and carries out printing on a print medium. To perform such processes, the print control section 200 has the setting reception portion 210 and the print data generator 230.

The setting reception portion 210 stores and manages settings for printing. The setting reception portion 210 receives changes of settings regarding printing, instructions for starting printing and print commands.

For example, the setting reception portion 210 causes an interface screen (not shown) for receiving various printing settings to be displayed on the operation panel 40. Through the operation panel 40, the setting reception portion 210 receives changes and the like of printing settings on the interface screen. When receiving a print command from the host computer 1, the setting reception portion 210 requests the print data generator 230 to generate print data in accordance with the print command.

In this embodiment, the setting reception portion 210 manages a setting of ON/OFF of the toner save mode for every feeder of the printer 2. Therefore, the setting reception portion 210 has the toner save setting information 220, for example, as shown in FIG. 3. The toner save setting information 220 has an entry for every feeder. Each entry includes feeder ID 221, which is information identifying a feeder, and toner save ON/OFF information 222, which is information representing ON/OFF of the toner save mode.

As a matter of course, the above-mentioned configuration of the toner save setting information 220 is one example, and the configuration is not limited to that mentioned above. The method of managing the toner save setting information 220 is not limited to a method using a table.

The setting reception portion 210 receives the setting of ON/OFF of the toner save mode on a feeder-by-feeder basis through the operation panel 40, and reflects the setting in the toner save on/off information 222 of the toner save setting information 220. When receiving a command that requests information (the toner save setting information 220) representing ON/OFF of the toner save mode set for every feeder from the host computer 1, the setting reception portion 210 sends the toner save setting information 220 to the host computer 1.

As described above, a user can freely change the setting of ON/OFF of the toner save mode for every feeder of the printer 2 through the operation panel 40. In accordance with a user's operation, the content of the toner save on/off information 222 changes.

As a matter of course, the setting of ON/OFF of the toner save mode on a feeder-by-feeder basis in the printer 2 is not limited to a setting method through the operation panel 40 as mentioned above. For example, as shown in FIG. 8, feeders 31 to 33 (the feeders 1 to 3) may respectively include hard switches 34 to 36 that can switch ON/OFF of the toner save mode. That is, the ON/OFF of each of the hard switches 34 to 36 is detected by the setting reception portion 210 and is reflected in the toner save on/off information 222 of the toner save setting information 220.

With reference back to FIG. 2, upon receiving a printing request from the setting reception portion 210, the print data generator 230 generates print data on the basis of various printing settings and data to be printed included in a print command. On the basis of the generated print data, the print data generator 230 controls the printing engine 30 to carry out printing on a print medium.

In this embodiment, the print data generator 230 determines whether to carry out printing in the toner save mode, on the basis of information identifying the selected feeder and information representing ON/OFF of the toner save mode for the feeder, both of the information being included in the print command. In the case where the toner save mode of the selected feeder is ON, the print data generator 230 performs a predetermined process of reducing the amount of toner used to generate print data. In the case where the toner save mode is OFF, the print data generator 230 performs a predetermined normal process to generate print data.

As the predetermined process of reducing the amount to toner used, for example, a process that converts the gradation values (density values) of cyan, magenta, yellow and black (CMYK) of image data to be printed into the gradation values (density values) obtained as a result of reduction in accordance with a predetermined toner reduction rate can be adopted. As a matter of course, the toner saving method is not limited to this method, and may be, for example, a method of varying laser light exposure and developing bias to reduce the toner consumption, a method of thinning out dot data obtained by binarizing a CMYK image in accordance with the predetermined reduction rate, and the like.

Note that the predetermined process for reducing the amount of toner may be performed in the printer driver section 100. In this case, the printer 2 does not perform the predetermined process of reducing the amount of toner. The print command need not include information representing ON/OFF of the toner save mode for the selected feeder.

The above-described elements are obtained by classifying the configurations regarding the toner save mode of the host computer 1 and the printer 2 according to the main process features in order to facilitate understanding of the configurations. The way of classifying elements and their names imposes no limitation on the present invention. The configurations of the host computer 1 and the printer 2 can be classified into more elements according to the contents of processes. The classification can be made so that one element performs more processes. The process of each element may be performed by one piece of hardware, or may be performed by a plurality of pieces of hardware.

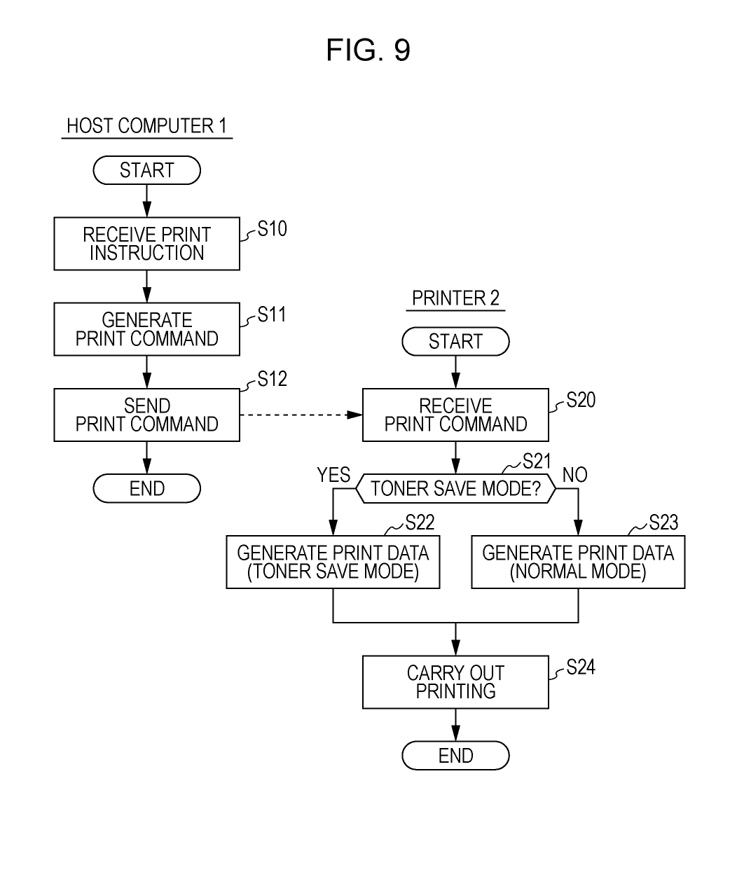

FIG. 9 is a flowchart showing a printing process in the printing system 3.

In S10, the setting reception portion 110 receives a print instruction. Specifically, for example, through the printing screen or the like of the application section, the setting reception portion 110 receives from a user an instruction that printing of data to be printed be started. The setting reception portion 110 acquires various printing settings set on the interface screen, and requests the print command generator 130 to generate a print command on the basis of the printing settings. Then, the process proceeds to S11.

In S11, the print command generator 130 generates a print command. Specifically, the print command generator 130 acquires the various printing settings set on the interface screen from the setting reception portion 110. The print command generator 130 acquires the specified data to be printed through the application section. The print command generator 130 generates a print command including the various printing settings and the data to be printed. Then, the process proceeds to S12.

In S12, the print command generator 130 sends the print command to the printer 2. Specifically, the print command generator 130 sends the print command generated in S11 to the printer 2. Then, this flow ends.

In S20, the setting reception portion 210 receives the print command from the host computer 1. Specifically, upon receiving the print command from the host computer 1, the setting reception portion 210 requests the print data generator 230 to generate print data according to that print command. Then, the process proceeds to S21.

In S21, the print data generator 230 determines whether to carry out printing in accordance with the print command in the toner save mode. Specifically, the print data generator 230 determines, on the basis of information identifying a feeder and information representing ON/OFF of the toner save mode for the feeder that are included in the print command, whether to carry out printing on the toner save mode. If the toner save mode is ON (S21: YES), the process moves to S22. If the toner save mode is OFF (S21: NO), the process moves to S23.

In S22, the print data generator 230 generates print data using the toner save mode. Specifically, the print data generator 230 performs the predetermined process of reducing the amount of toner used to generate print data. Then, the process proceeds to S24.

In S23, the print data generator 230 generates print data using the normal mode. Specifically, the print data generator 230 performs the normal predetermined process to generate print data. Then, the process proceeds to S24.

In S24, the print data generator 230 carries out printing. Specifically, the print data generator 230 controls the printing engine 30 on the basis of the print data generated in S22 or S23 to carry out printing on a print medium of a feeder specified by the print command.

The above-described process units shown in FIG. 9 are obtained by dividing processes of the host computer 1 and the printer 2 according to the main process features in order to facilitate understanding of the processes. The way of dividing the processes into process units and their names imposes no limitation on the present invention. The processes of the host computer 1 and the printer 2 can be divided into more process units according to the process features. The processes can also be divided so that one process unit includes more processes.

Hereinabove, an embodiment of the invention has been described. According to this embodiment, the ease-of-use of the toner save mode in an image forming device can be improved.

That is, in this embodiment, the initial setting of ON/OFF of the toner save mode can be set beforehand. When a user gives a higher priority to the toner save mode than to the normal mode, it is only necessary for the initial setting of the toner save mode to be ON. A user need not set the toner save mode at every time of printing.

In this embodiment, the ON/OFF of the toner save mode can be set on a feeder-by-feeder basis. When a user gives a higher priority to the toner save mode for printing using a specific feeder, it is only necessary for the initial setting of the toner save mode of the feeder to be ON. A user need not set the toner save mode at every time of printing.

In this embodiment, the ON/OFF of the toner save mode for every feeder can be directly set in the image forming device. Then, the setting in the image forming device can be acquired using the driver program of the host computer and can be reflected as the initial setting. Such a configuration allows the setting in the image forming device to be used as the default setting. The configuration also allows the setting in the image forming device to be used as the default setting common to a plurality of users.

The above-described embodiment of the invention is intended to be illustrative of the spirit and scope of the invention, and is not to be taken in a limiting sense. Many alternatives, changes and modifications are apparent to those skilled in the art.

For example, while the image forming device stores a setting of the toner save mode for every feeder in the above-described embodiment, the image forming device need not store the setting. The image forming device may receive a specification of ON/OFF of the toner save mode on a feeder-by-feeder basis only by a print command from a driver so as to carry out printing.

For example, while the initial setting of the toner save mode stored in the driver is preferentially applied to printing in the above-described embodiment, the initial setting of the toner save mode stored in the image forming device may be preferentially applied to printing. Specifically, upon activation of the printer driver section 100, the setting reception portion 110 is configured to acquire the toner save setting information 220 stored in the print control section 200 and to reflect the acquired toner save setting information 220 in the toner save setting information 120. The setting reception portion 110 is configured only to display setting contents on the basis of the toner save setting information 120, so that a user cannot change the settings. Note that, in this case, information representing ON/OFF of the toner save mode need not be included in the print command.

With a configuration as described just above, the setting of the toner save mode stored in the image forming device is preferentially applied to printing. Such a configuration makes it possible for all of a plurality of users to compulsorily use a common setting of the toner save mode.

For example, when a feeder is selected in the driver, “automatic selection” may be allowed to be set. The “automatic selection” means a function such that the image forming device automatically selects an appropriate feeder according to a paper size specified for data to be printed, a paper size selected in the driver, or the like.

Specifically, an entry of “automatic selection” is included in the toner save setting information 120. When “automatic selection” is selected, the print command generator 130 causes information identifying a feeder of “automatic selection” and information representing ON/OFF of the toner save mode for the feeder of “automatic selection” to be included in a print command. The print data generator 230 automatically selects an appropriate feeder for printing, and generates print data according to ON/OFF of the toner save mode included in the print command.

With a configuration as described just above, in the case of “automatic selection”, the initial setting of the toner save mode can be set. Additionally, in the case of “automatic selection”, the initial setting of the actually selected feeder on the image forming device side may be preferentially applied to printing. Also, in the case of “automatic selection”, the initial setting for every feeder on the driver side may be sent to the image forming device, so that the initial setting of the actually selected feeder is applied to printing.

For example, the method of setting ON/OFF of the toner save mode for every feeder can be similarly applied to cases in which an image forming device such as a copier, a multifunction printer or the like having a copying function independently carries out copying.

Specifically, the image forming device is made up of a scanner engine, a printing engine, an operation panel, a controller and the like. Implemented in the controller are a setting reception portion that receives a copy setting through an operation panel, a reading control portion that controls the scanner engine on the basis of the copy setting to scan an image, and a printing control portion that processes image data scanned on the basis of copy setting to carry out printing.

Here, the setting reception portion has toner-saving setting information (similar to FIG. 3), and has a setting of ON/OFF of the toner saving for every feeder. In the same way as in the setting reception portion 110 of the above-described embodiment, the default setting is in accordance with toner-saving setting information. The setting reception portion can receive selection of ON/OFF of the toner saving without changing the content of toner-saving setting information at every time of copying. The setting reception portion also can receive a change of the content of toner-saving setting information.

Upon receiving an instruction for copying through an operation panel or the like, the setting reception portion instructs the reading control portion to carry out scanning The setting reception portion causes the printing control portion to carry out printing on the basis of image data scanned by the reading control portion. At this point, the printing control portion acquires a copy setting from the setting reception portion and determines whether the toner save mode of the specified feeder is ON. In the case of ON, the printing control portion performs the predetermined process for reducing toner and carries out printing.

With the above-described configuration, when the image forming device having a copying function operates independently, the ease-of-use of the toner save mode can be improved. As a matter of course, each feeder may have a hard switch that can switch ON/OFF of the toner save mode. An image forming device such as a copier, a multifunction printer or the like having a copying function may also have a printer function, and may receive a print instruction from the driver.

For example, the ON or OFF of the toner saving may be displayed together with the selection of the feeder.

Specifically, the setting reception portion 110 specifies the ID of a feeder set in the feeder field 511 (FIG. 4), refers to the toner save setting information 120 (FIG. 3), and acquires the toner save ON/OFF information 122 of the entry of the feeder ID. Information corresponding to the acquired toner save ON/OFF information 122 (ON or OFF) is displayed together with the information specifying the feeder in the feeder field 511. For example, when “feeder 3” is selected, “feeder 3 (toner save ON)” is displayed. Note that when the toner saving is OFF, the information need not be displayed.

For example, the ON or OFF of the toner saving may be allowed to be set together with the selection of the feeder.

Specifically, the Basic Settings screen 510 includes a toner save field, which has the same function as the Toner Save field 610 (FIG. 6), near (e.g., right or below) the feeder field 511. The setting reception portion 110 displays information, which corresponds to the toner save ON/OFF information 122 (ON or OFF) of the feeder set in the feeder field 511, in the toner save field near the feeder field 511.

For example, when the feeder 3 is set in the feeder field 511 (see FIG. 4) and the toner save ON/OFF information 122 of the feeder 3 is set to ON (see FIG. 3), the toner save field near the feeder field 511 is set to ON (if this toner save field is a check box, the box is checked).

The setting reception portion 110 receives the setting of ON/OFF of the toner save mode of a feeder selected in the feeder field 511 by using the toner save field near the feeder field 511. However, the content of the toner save ON/OFF information 122 does not change. That is, a user can temporarily change the ON or OFF of the toner save regardless of the initial setting.

It is to be noted that various changes and modifications described herein may be combined as appropriate.

The entire disclosure of Japanese Patent Application No. 2009-285006, filed Dec. 16, 2009 and No. 2010-112918, filed May 17, 2010 are expressly incorporated by reference herein.

What is claimed is:

1. A printing system, comprising a printing device having one or more feeders, and a computer,
the computer including:
a setting reception unit that stores beforehand a setting of ON or OFF of a colorant save mode in which a process of saving a colorant is performed for every one of the feeders, and receives a print instruction including selection of a feeder; and
a command sending unit that, on the basis of the feeder selected in the print instruction and a setting of ON or OFF of the colorant save mode of the feeder, generates a print command and sends the print command to the printing device; and
the printing device including:
a print control unit that, on the basis of the print command sent from the computer, performs a predetermined process of saving a colorant when the colorant save mode is ON, generates print data, and carries out printing using the feeder selected in the print command.

2. A printing system, comprising a printing device having one or more feeders, and a computer,
the computer including:
a setting reception unit that stores beforehand a setting of ON or OFF of a colorant save mode in which a process of saving a colorant is performed for every one of the feeders, and receives a print instruction including selection of a feeder; and
a command sending unit that, on the basis of the feeder selected in the print instruction and ON or OFF of the colorant save mode of the feeder, performs a predetermined process of saving a colorant when the colorant save mode is ON, generates a print command, and sends the print command to the printing device; and
the printing device including:
a print control unit that, on the basis of the print command sent from the computer, generates print data, and carries out printing using the selected feeder.

3. The printing system according to claim 1, wherein
the setting reception unit receives a setting of ON or OFF of the colorant save mode for the selected feeder, and
the command sending unit generates a print command on the basis of the setting of ON or OFF of the colorant save mode received for the selected feeder.

4. The printing system according to claim 3, wherein the setting reception unit receives a change of the beforehand stored setting of ON or OFF of the colorant save mode for every feeder.

5. A computer readable storage medium, comprising a printer driver program stored thereon that causes a computer to function as a device for sending a print command to a printing device having one or more feeders, the printer driver program causing the computer to function as:
a setting reception unit that stores beforehand a setting of ON or OFF of a colorant save mode in which a process of saving a colorant is performed for every one of the feeders, and receives a print instruction including selection of a feeder; and
a command sending unit that, on the basis of the feeder selected in the print instruction and ON or OFF of the colorant save mode of the feeder, generates a print command, and sends the print command to the printing device.
